(19) United States
(12) Patent Application Publication
(10) Pub. No.: US 2014/0340515 A1
(43) Pub. Date: Nov. 20, 2014

(54) IMAGE PROCESSING METHOD AND SYSTEM

(71) Applicant: Panasonic Corporation, Osaka (JP)

(72) Inventors: Tetsuo TANAKA, Fukuoka (JP); Jun IKEDA, Fukuoka (JP); Shinichi TSUKAHARA, Fukuoka (JP)

(73) Assignee: Panasonic Corporation, Osaka (JP)

(21) Appl. No.: 14/277,268

(22) Filed: May 14, 2014

(30) Foreign Application Priority Data
May 14, 2013 (JP) 2013-101874
Apr. 21, 2014 (JP) 2014-087663

(51) Int. Cl. G06T 5/50; H04N 7/18; H04N 5/33; G06T 7/00

(52) U.S. Cl. CPC G06T 5/50; G06T 7/0085; H04N 7/18; H04N 5/33
USPC 348/143; 382/199

(57) ABSTRACT

A first image and a second image are obtained from a same image object under a first condition and a second condition, respectively, and the first image is edge enhanced by using information obtained from the second image. A first edge amount is obtained from each of a plurality of first pixels of the first image, and a second edge amount is obtained from each of a plurality of second pixels of the second image. Each pixel of the first image is edge enhanced according to the sign of the first edge amount thereof and the second edge amount of the corresponding second pixel.

### TECHNICAL FIELD

The present invention relates to an image processing method and system for edge enhancement by combining an edge component of a first image of an object with a second image of the same object acquired under a different imaging condition.

### PRIOR ART

An increasing number of local municipalities are installing monitor cameras for disaster control as a part of the increased awareness for the need to protect the population from various natural disasters. As one such form of monitor cameras, cameras for monitoring tsunami are known. According to various systems that are now under development for local municipalities, cameras for monitoring tsunami are typically installed on the coast to remotely monitor the condition of the sea and the beaches, and if any people are detected near the coast at the time of a severe earthquake, to encourage the people near the coast to evacuate by using an emergency wireless communication system.

A monitor camera for disaster control is required to be capable of acquiring clear and natural images under all conditions. However, in an inclement weather condition such as heavy rain and dense fog, images acquired in visible light are often blurred and unclear. Such a problem can be at least reduced by using an infrared camera that is sensitive to an infrared wavelength band. As infrared light is less prone to dispersion, and is less likely to be blocked by fog or other minute water droplets, an infrared camera is capable of acquiring relatively clear images even under most unfavorable weather conditions.

If the wavelength of the infrared light is longer than 4,000 nm, the wavelength may be greater than the pixel size of a camera that is typically used for such a purpose so that the precision in the gradation of each pixel may be reduced, and the clarity of the obtained image may be reduced. Therefore, the near infrared light in the wavelength range of 700 nm-1,500 nm is preferred for monitor cameras for disaster control. The near infrared light is less prone to dispersion as compared to the visible light, and has a shorter wavelength than the pixel size of the image sensor with the result that the precision in the gradation of each pixel can be ensured, and the sharpness of the edges in the acquired image can be ensured. However, when the image acquired by a near infrared camera is reproduced on a display device, the original colors are substantially lost, and do not correspond to normal human perception. For instance, the blue sky appears dark, and green leaves appear white.

A monitor camera for disaster control is required to be capable of reproducing sharp edges to allow an object to be monitored to be distinguished from the background in order for the camera to meet the need to accurately detect the condition of the coast and the state of the people in the area.

According to the technology disclosed in Patent Document 1, image sensors having R, G and B pixels and Ir pixels (pixels sensitive to RGB and near infrared light without using color filters) are used, and the image based on the Ir pixels and the image based on the RGB pixels are combined. According to this technology, the image data based on the Ir pixels is used for obtaining brightness information, the Ir component is removed from the image based on the RGB to provide color components therefrom, and a pseudo color image is produced by combining the brightness information and the color components.

It was also proposed in Patent Document 2 to use image sensors having R, G, B and Ir pixels similarly as in Patent Document 1, and change the coefficients of an edge enhancing filter for the visible light image according to the information of one of the visible light component and the infrared component demonstrating sharper edges. According to the prior art disclosed in Patent Document 2, failure to detect edges can be avoided, and an appropriate filtering can be applied to the edges in a reliable manner.

### CITATION LIST

### Patent Literature

[PTL1] JP2007-184805A
[PTL 2] JP2008-283541A

### SUMMARY OF THE INVENTION

### Task to be Accomplished by the Invention

However, the edge components may not be contained in a same pattern in the visible light image and the infrared light image. Depending on the condition under which the image is acquired, the edge components may be lost in both the visible light image and the infrared light image, and the directions of edges (such as rising edges and falling edges) may be reversed for the same edges. According to the technology disclosed in Patent Document 1, because the luminance information (edge components) are not considered in generating the pseudo color image, if the edge directions of the visible light image and the infrared light image are reversed, the edges may disappear to a large extent when the images are combined.

According to the technology disclosed in Patent Document 2, when the visible light image which is required to be edge enhanced contains almost no edge components, it is practically impossible to reconstruct the edges no matter what filter coefficients are used.

In view of such problems of the prior art, a primary object of the present invention is to provide an image processing method that can enhance edges of an image even when edges are not clearly visible in visible light.

A second object of the present invention is to provide an image processing method that can produce a clear image of an object even under most adverse weather conditions.

A third object of the present invention is to provide a system that is suitable for implementing such a method.

### Means to Accomplish the Task

The present invention can accomplish such objects by providing an image processing method, comprising the steps of: extracting a first edge amount for each of a plurality of first image segments forming an image of an image object obtained under a first condition as a relative value with respect to at least one adjoining first image segment; extracting a second edge amount for each of a plurality of second image segments forming an image of the same image object obtained under a second condition different from the first condition as a relative value with respect to at least one adjoining second image segment; and edge enhancing the image obtained under the first condition for each first image segment thereof according to a sign of the corresponding first edge amount and the second edge amount of the corresponding second image segment.

### Effect of the Invention

The present invention makes use of a first image and a second image of a same image object captured under different conditions, and can enhance the edges of the first image by using the second image.

### BRIEF DESCRIPTION OF DRAWINGS

FIG. 1 is a structure view showing an overall structure of an image processing system given as a first embodiment of the present invention;

FIG. 2 is a block diagram of the image processing system;

FIG. 3a is a diagram illustrating an object pixel and adjacent pixels surrounding the object pixel which are to be processed by a first edge extracting unit;

FIG. 3b is a flowchart showing the process executed by the first edge extracting unit;

FIG. 4a is a diagram illustrating an object pixel and adjacent pixels surrounding the object pixel which are to be processed by a second edge extracting unit;

FIG. 4b is a flowchart showing the process executed by the second edge extracting unit;

FIG. 5 is a flowchart showing the process executed by a noise pixel determining unit;

FIG. 6 is a flowchart showing the process executed by an edge component generating unit;

FIG. 7 is a table showing the effect of considering the edge direction of the visible light data (Y) on the results of edge enhancement;

FIG. 8 is a graph showing the results of edge enhancement given in FIG. 7;

FIG. 9 is a table showing the result of edge enhancement when the noise pixel determination has been performed and has not been performed while the edge direction of the visible light image is considered;

FIG. 10 is a graphic representation of the result of edge enhancement shown in FIG. 9;

FIG. 11 is a view similar to FIG. 1 showing the structure of an image processing system given as a second embodiment of the present invention; and

FIG. 12 is a view similar to FIG. 1 showing the structure of an image processing system given as a third embodiment of the present invention.

### DESCRIPTION OF THE PREFERRED EMBODIMENTS

The present invention provides an image processing method, comprising the steps of: extracting a first edge amount for each of a plurality of first image segments forming an image of an image object obtained under a first condition as a relative value with respect to at least one adjoining first image segment; extracting a second edge amount for each of a plurality of second image segments forming an image of the same image object obtained under a second condition different from the first condition as a relative value with respect to at least one adjoining second image segment; and edge enhancing the image obtained under the first condition for each first image segment thereof according to a sign of the corresponding first edge amount and the second edge amount of the corresponding second image segment.

The present invention makes use of a first image and a second image of a same image object captured under different conditions, and edge enhances the first image by using the second image.

According to a certain aspect of the present invention, for each first image segment, a value based on an absolute value of the corresponding second edge amount is added to the first edge amount of the first image segment when the first edge amount is positive, and a value based on an absolute value of the corresponding second edge amount is subtracted from the first edge amount of the first image segment when the first edge amount is negative.

As a result, even when the edge direction of a certain edge is different between the first image and the second image which are based on the same image object, the edge of the first image can be effectively enhanced by using the edge component of the second image.

According to another aspect of the present invention, the first edge amount for each first image segment is given as a difference between a value of the first image segment and an average of values of surrounding first image segments, and the second edge amount for each second image segment is given as a difference between a value of the second image segment and an average of values of surrounding second image segments.

The value of each first image segment may be given by a pixel value of luminance information of the first image segment.

The second condition differs from the first condition in a wavelength of light that is used.

Thereby, an unclear edge in the first image can be enhanced by the edge component of the corresponding edge in the second image which is acquired in a different wavelength.

The image obtained under the first condition may comprise a visible light image, and the image obtained under the second condition may comprise an infrared light image.

Thus, even when an edge of a visible light image is blurred owing to dense fog or other adverse weather conditions, the edge of the visible light image can be enhanced by using the corresponding edge component of the infrared light image. As the finally obtained image is based on the visible light image, the produced image demonstrates a natural appearance and very well corresponds to the normal perception of a human eye.

Typically, the images obtained under the first and second conditions cover a same region of the image object.

The first and second image segments may consist of pixels.

The method of the present invention may further comprise the step of determining if each first image segment is a noise image segment containing noises according to the corresponding first edge amount and second edge amount; when the first image segment consists of a noise image segment, the step of edge enhancing the image obtained under the first condition being based solely on the corresponding second edge amount.

Thereby, when the first pixel consists of a noise pixel, the sign based on the first edge amount is disregarded when generating the edge component so that an unnatural edge due to noises can be avoided.

When the first edge amount of one of the first image segments normalized according to a contrast thereof is smaller than the second edge amount of the corresponding second image segment, the said first image segment may be determined as a noise image segment.

By properly adjusting the dynamic ranges of the first image and the second image, determination of noise pixels in the first image can be more accurately performed.

The present invention also provides an image processing system, comprising: an image acquiring unit for acquiring an image of an image object under a first condition and acquiring an image of the same image object under a second condition different from the first condition; a first edge amount extracting unit for extracting a first edge amount for each of a plurality of first image segments forming the image obtained under the first condition as a relative value with respect to at least one adjoining first image segment; a second edge amount extracting unit for extracting a second edge amount for each of a plurality of second image segments forming the image obtained under the second condition as a relative value with respect to at least one adjoining second image segment; and an edge enhancement processing unit for edge enhancing the image obtained under the first condition for each first image segment thereof according to a sign of the corresponding first edge amount and the second edge amount of the corresponding second image segment.

As a result, by making use of a first image and a second image of a same image object captured under different conditions, the edges of the first image can be enhanced by using the second image.

According to a preferred embodiment of the present invention, the image acquiring unit comprises a camera configured to capture an image in both visible light and infrared light, and an infrared light cut filter that can be selectively placed in an optical system of the camera, the first condition being achieved by placing the infrared light cut filter in the optical system, and the second condition being achieved by removing the infrared light cut filter from the optical system.

Thereby, a simple camera such as a single lens camera can be used for acquiring both a visible light image and an infrared light image.

The image acquiring unit may also comprise a first camera for capturing an image under the first condition and a second camera for capturing an image under the second condition.

Thus, by using a twin lens camera, a visible light image and an infrared light image can be captured at the same time.

According to a preferred embodiment of the present invention, the edge enhancement processing unit adds a value corresponding to an absolute value of the second edge amount to a value of the first image segment when a sign of the first edge amount is positive, and subtracts a value corresponding to an absolute value of the second edge amount from a value of the first image segment when a sign of the first edge amount is negative.

Thus, even when the edge direction (rising edge or falling edge) of a certain coordinate differs between the first image and the second image based on the same image object, the edge of the first image can be effectively enhanced by using the corresponding edge component of the second image.

According to a particularly preferred embodiment of the present invention, the first edge amount extracting unit gives the first edge amount of each first image segment by a difference between a value of the first image segment and an average of values of surrounding first image segments, and the second edge amount extracting unit gives the second edge amount of each second image segment by a difference between a value of the second image segment and an average of values of surrounding second image segments.

The value of each first image segment may be given by a pixel value based on luminance information of the first image segment.

The second condition may differ from the first condition in a wavelength of light that is used.

Thereby, a blurred edge in the first image can be enhanced by using the corresponding edge component of the second image captured in the light of a different wavelength.

The image obtained under the first condition may comprise a visible light image, and the image obtained under the second condition may comprise an infrared light image. Typically, the images obtained under the first and second conditions cover a same region of the image object.

Thus, even when an edge of a visible light image is blurred owing to dense fog or other adverse weather conditions, the edge of the visible light image can be enhanced by using the corresponding edge component of the infrared light image. As the finally obtained image is based on the visible light image, the produced image demonstrates a natural appearance and very well corresponds to the normal perception of a human eye.

### First Embodiment

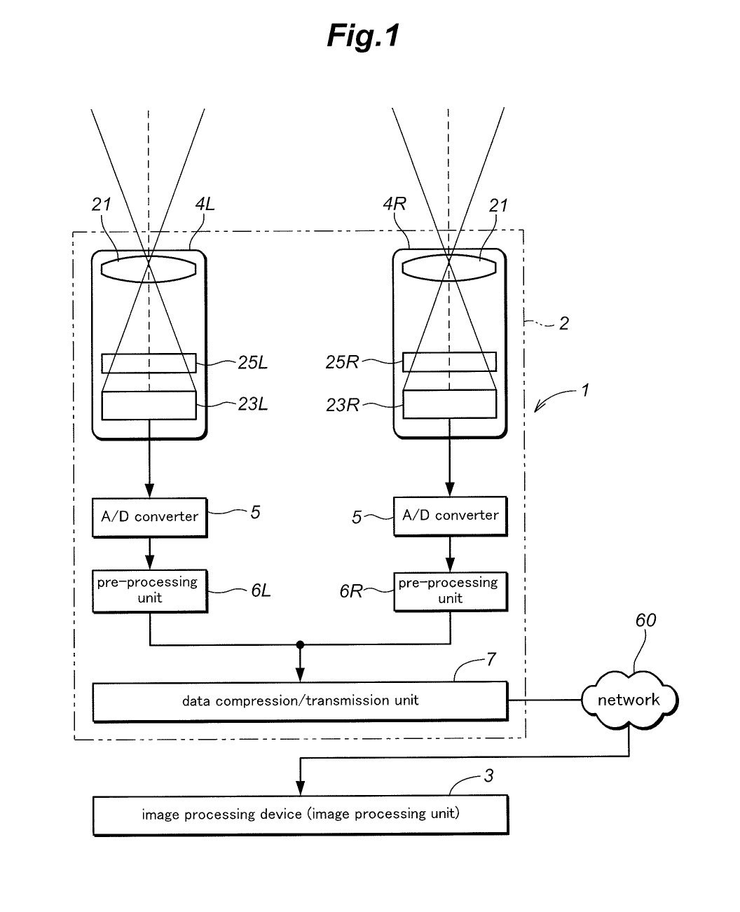

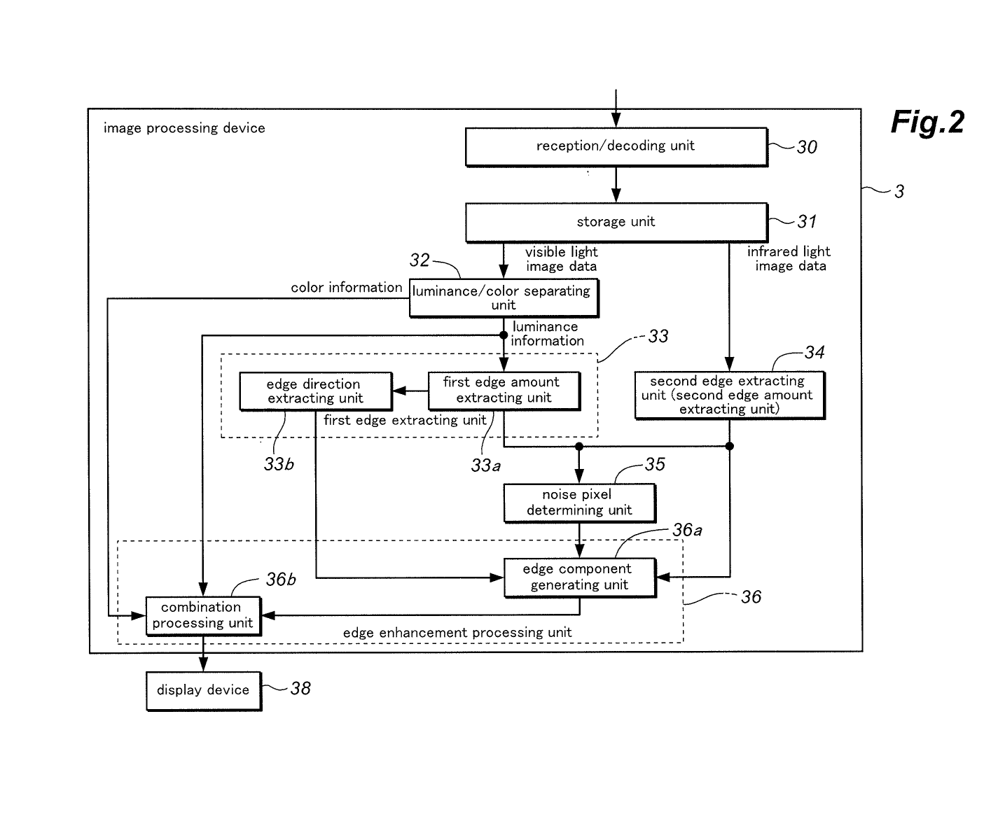

FIG. 1 is a structure view showing an overall structure of an image processing system given as a first embodiment of the present invention. As shown in FIG. 1, the image processing system 1 comprises an image acquiring unit 1 and an image processing device 3. The image acquiring unit 1 and the image processing device 3 may be connected to each other via a network 60 such as the Internet so that image data generated by the image acquiring unit 2 may be transmitted to the image processing device 3 which may be remotely located, and displayed on a display device 38 (see FIG. 2). Various command signals for controlling the image acquiring unit 2 are transmitted from the image processing device 3 to the image acquiring unit 2.

The image data is transmitted from the image processing device 3 to the image acquiring unit 2 by using TCP/IP or the Internet protocol, but may also be transmitted as a so-called CCTV (closed circuit TV) where the image acquiring unit 2 and the image processing device 3 are connected to each other via a dedicated communication line in a one to one relationship.

The image acquiring unit 2 includes a left camera (first camera) 4L, a right camera (second camera) 4R, a pair of A/D converters 5, a pair of pre-processing units 6L and 6R and a data compression/transmission unit 7. Thus, the image acquiring unit 2 of this embodiment is configured as a twin lens camera.

The left camera 4L consists of an optical system including a lens 21, an infrared light cut filter 25L and an imaging device 23L. The imaging device 23L consists of a CMOS (complementary metal oxide semiconductor) or CCD (charge coupled device) color image sensor where pixels provided with color filters transmitting R (red), G (green) and B (blue) colors arranged in the Bayer pattern layout (such as RGGB pattern). Owing to the use of the infrared light cut filter 25L for the left camera 4L, the imaging device 23L produces an analog image signal corresponding to the visible light image (380 nm-810 nm). The imaging device 23L may also use a monochromatic image sensor having no color filters.

The right camera 4R consists of an optical system including a lens 21, an infrared light pass filter (visible light cut filter) 25R and an imaging device 23R. The imaging device 23R consists of a CMOS or CCD image sensor similarly as the left camera 4L, but no color filter is provided on the imaging surface of the imaging device 23R. Owing to the use of the infrared light pass filter 25R for the right camera 4R, the imaging device 23R produces an analog image signal corresponding to the near infrared (Ir) light image (810 nm-1,500 nm).

The left camera 4L and the right camera 4R are operated by the same timing so that a first image (visible light image) captured under a first condition based on visible light and a second image (infrared light image) captured under a second condition based on infrared light are captured simultaneously. The analog signals produced from the left camera 4L and the right camera 4R are converted into digital image signals by the two A/D converters 5, respectively.

The digital image data based on the analog image signal from the left camera 4L is forwarded to the corresponding pre-processing unit 6L. The pre-processing unit 6L performs demosaicing, white balance adjustment, color correction and gradation correction (gamma correction) on the image data. By the demosaicing process, image data (visible light image data) can be obtained for each of the R, G and B planes.

The digital image data based on the analog image signal from the right camera 4R is forwarded to the corresponding pre-processing unit 6R. The pre-processing unit 6R performs gradation correction (gamma correction) on the image data to provide image data in the Ir plane (infrared light image data). In the following description, the infrared light image data and the visible light image may be collectively referred to as “image data”. The demosaicing process is performed in such a manner that the numbers of pixels in the R, G and B planes and the Ir plane are the same to one another.

As will be discussed hereinafter, the luminance information is generated from the visible light image data in the first embodiment. In the following description, to distinguish the visible light image data based on the RGB basic colors and the visible light image based on the luminance information from each other, the visible light image data based on the RGB basic colors will be referred to as “visible light image data (RGB)” and the visible light image based on the luminance information will be referred to as “visible light image data (Y)”. The images constructed from such data will be referred to as “visible light image (RGB)” and “visible light image (Y)”, respectively.

The left camera 4L and the right camera 4R are provided with identical optical systems each including a lens 21, and the imaging devices 23L and 23R of these cameras have a same resolution (same number of pixels and same size). Therefore, when the distance between the image acquiring unit 2 and the object is adequately great (as is typically the case with disaster monitoring cameras), the left camera 4L and the right camera 4R capture a substantially identical object. In other words, in the x-y plane of the pixels of each color R, G, B and Ir, each point of the object essentially falls on an identical x-y coordinate.

As it is difficult to align the optical axial lines of the left camera 4L and the right camera 4R exactly parallel to each other and to completely match the optical magnifications and the image circles, a positioning unit (not shown in the drawings) may be provided behind each pre-processing unit 6L, 6R so that the edge positions of the left and right images may coincide with each other. The positioning unit may be configured to perform the per se known feature point matching process by detecting the rising edges and falling edges (paired edges) of the left and right images (the G plane image from the left camera 4L and the Ir plane image from the right camera, for instance). Based on the result of this matching, an affine transformation is performed on the Ir plane. Thereby, it can be ensured that each pixel of a same coordinate corresponds to an identical position of the object for the visible light image data (RGB) and the infrared light image data (Ir). As will be discussed hereinafter, as the directions of edges may be reversed between the visible light image data (RGB) and the infrared light image data (Ir), it is preferable to perform the positioning process mentioned above on paired edges from which the direction or sign is excluded. By obtaining the parameters for the affine transformation in advance by using a prescribed chart, the need for the positioning process may be eliminated. If the positioning process is to be performed, it is not necessary to make the captured regions of the left and right images to coincide with each other, but the edge enhancing process (which will be described hereinafter) may be applied only to those parts of the images that coincide with each other to enhance the edge of the first image.

The visible light image data (RGB) and the infrared light image data (Ir) are subjected to a per se known compression process in the data compression/transmission unit 7, and is transmitted to the image processing device 3 via a network 60. According to a command of the operator of the image processing system 1, the compressed image data in the JPEG format, for example, in the case of still images or in the JPEG format or the H.264 format, for example, in the case of motion pictures is transmitted to the image processing device 3. If the visible light image data (RGB) is separated into luminance information and color information, it is not necessary to separate the luminance information and color information in the image processing device 3.

FIG. 2 is a block diagram showing the structure of the image processing device 3. The image processing device 3 comprises a reception/decoding unit 30, a storage unit 31, a luminance/color information separating unit 32, a first edge extracting unit 33, a second edge extracting unit (second edge amount extracting unit) 34, a noise pixel determining unit 35 and an edge enhancement processing unit 36.

The image processing device 3 is provided with a CPU (central processing unit) not shown in the drawings, work memory, program memory and a bus or the like for connecting the various components of the image processing device 3 one another. The CPU arbitrates the functions of the various components, and controls the overall operation of the image processing device 3. As can be readily appreciated, a part or a whole of the image processing device 3 may be implemented by dedicated hardware particularly when there is a need to reproduce movies at high speed, instead of a computer operating under a computer program.

The image data supplied to the image processing device 3 in the compressed state is decoded into the visible light image data (RGB) and the infrared light image data (Ir) by the reception/decoding unit 30. The visible light image data (RGB) and the infrared light image data (Ir) are temporarily stored in the storage unit 31, and the visible light image data (RGB) is forwarded to the luminance/color information separating unit 32 while the infrared light image data (Ir) is forwarded to the second edge extracting unit 34.

The luminance/color information separating unit 32 converts the individual components of the visible light image data (RGB) into the luminance information (Y) and the color information (I, Q). The conversion of RGB into YIQ can be performed by the following formula.

Y=0.30×R+0.59×G+0.11×B Eq. 1

I=0.60×R−0.28×G−0.32×B Eq. 2

Q=0.21×R−0.52×G+0.31×B Eq. 3

If the imaging device 23L of the image capturing unit 2 consists of a monochromatic image sensor, the visible light image (Y) is directly forwarded to the image processing device 3, and the processing by the luminance/color information separating unit 32 is not required. Also, the process by a combination processing 36b which will be described hereinafter to generate visible light image data (RGB) from the visible light image (Y) and the color information is not required.

Instead of the conversion to YIQ, the image captured by the image capturing unit 2 may be converted into YCbCr if the captured image consists of a SD image, and into YPbPr if the captured image consists of a HD image. In either case, the luminance information (visible light image data (Y)) and the color information can be obtained from the RGB information. In particular, the visible light image data (Y) forming the Y plane is forwarded to the first edge extracting unit 33. In the computation based on Eqs. 1 to 3, in the case of 8-bit computation, the visible light image data (Y) can be expressed by a value ranging from 0 to 255, and the color information (I, Q) can be expressed by a value ranging from −128 to +127.

The first edge extracting unit 33 comprises a first edge amount extracting unit 33a and an edge direction extracting unit 33b. The first edge amount extracting unit 33a of the first edge extracting unit 33 extracts an edge amount (first edge amount) for each pixel (the first pixel or the object pixel P which will be described hereinafter) of the visible light image data (Y). The edge direction extracting unit 33b detects the sign (positive or negative) of each first edge amount.

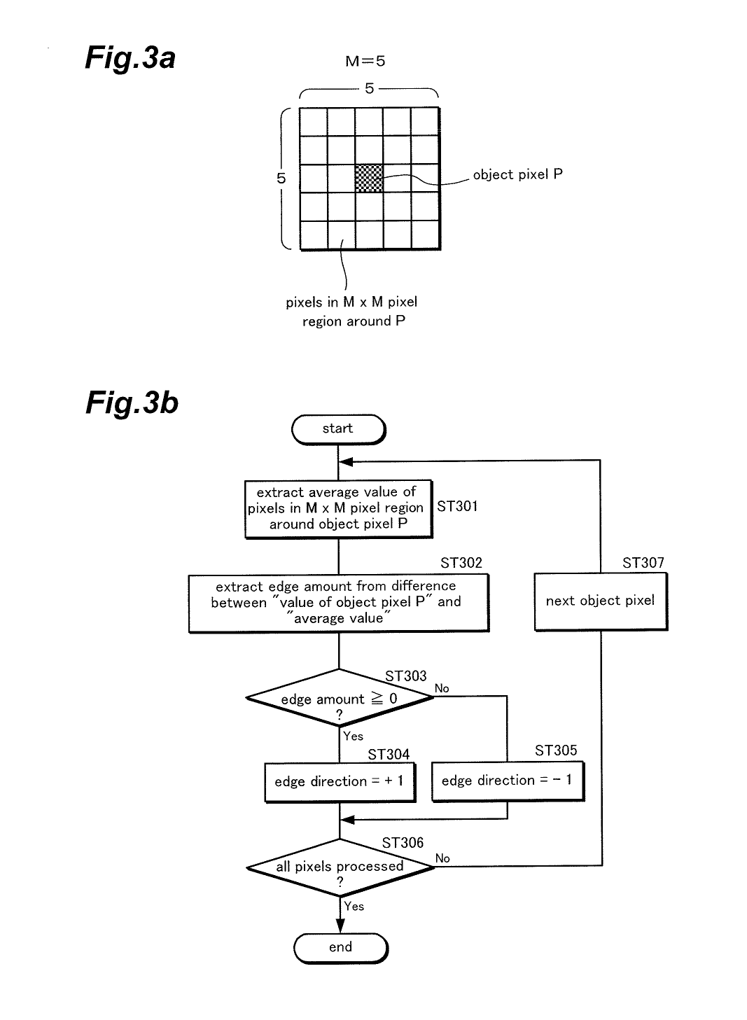

FIG. 3a illustrates each pixel which the first edge extracting unit 33 deals with, and FIG. 3b is a flowchart showing the process executed by the first edge extracting unit 33. The mode of operation of the first edge extracting unit 33 is described in the following with reference to FIGS. 2 and 3.

In the process executed by the first edge extracting unit 33, an M×M region (window, M=5) is defined around the object pixel P, and the window is shifted by one pixel as each corresponding object pixel is processed.

As shown in FIG. 3b, first of all, the first edge extracting unit 33 computes the average value of the pixels included in the M×M region of the entire visible light image data (Y) (ST301). The central pixel P may be either included in or excluded from this averaging process. The difference between the pixel value of the object pixel P and the average value is computed in step ST301 (“value of the object pixel P”−“average value”), and this difference (relative value) is set as a first edge value (ST302). The first edge value can be either positive or negative. It is then determined if the first edge value is equal to or greater than “0” or less than “0” (ST303).

The first edge amount may also be obtained by using a per se known edge detection filter, instead of using the average value of step ST301. The edge detection filter consists of a 3×3 matrix, for instance, and the central pixel is given as the object pixel P (with a positive value such as “+4”) while the values of four strongly connected pixels surrounding the central pixel is given with a negative value (such as “−1”). Any other coefficients can be used in this and other edge filters consisting of a M×M matrix such as the Laplacian filter, the Prewitt filter and the Sobel filter as long as the elements of the matrix are symmetric and add up to value “0”. By applying such a filter to the visible light image data (Y), the first edge amount for the object pixel P can be obtained.

The average value used for computing an edge amount may also be computed from a part of the surrounding pixels (such as the four pixels that are vertically and laterally adjacent to the object pixel P), instead of the entire M×M pixels surrounding the object pixel P.

When the “value of the first edge amount” equal to or greater than “0” (Yes in step ST303), the edge direction is given as “+1” (ST304). When the “value of the first edge amount” is less than “0” (No in step ST303), the edge direction is given as “−1” (ST305). In other words, the edge direction as used here indicates if the edge rises or falls. If the edge rises, the value is given by +1. If the edge falls, the value is given by −1. In the computer program, the edge direction is indicated by the sign (positive or negative) when computing the first edge amount. If the result of the computation of the first edge amount is non-negative, the edge direction is then given by “+1”.

The edge direction may be expressed by an independent flag, but may also be expressed by the sign of the first edge amount. However, as the first edge amount could be zero, it is necessary to choose either “+1” or “−1” when the first edge amount is equal to zero. The edge direction may also be determined from the result of the application of the edge detection filter mentioned above. In this case also, it is necessary to consider the possibility of the edge amount being equal to zero.

Upon completion of step ST304 or ST305, it is determined if the foregoing process has been executed to all of the object pixels (ST306). If so (Yes in step ST306), the program flow is ended. If no (No in step ST306), a window centered around the next object pixel is defined (ST307).

Reference is made to FIG. 2 once again. In FIG. 2, the infrared light image data temporarily stored in the storage unit 31 is forwarded to the second edge amount extracting unit 34. The second edge amount extracting unit 34 extracts the edge amount (second edge amount) from each of the pixels (the second pixels or the object pixels Q) of the infrared light image.

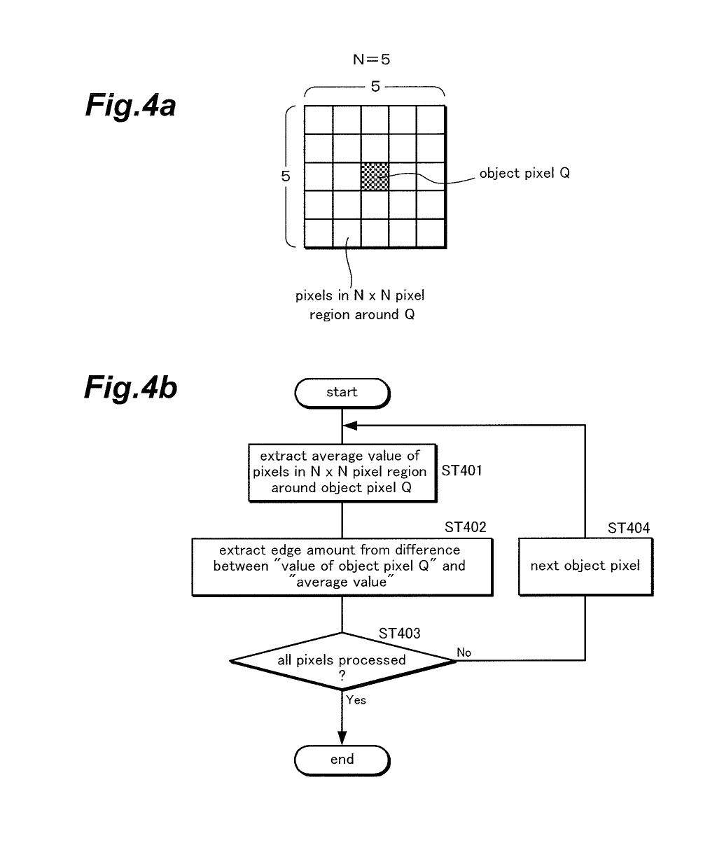

FIG. 4a is a view illustrating each pixel which the second edge extracting unit 34 deals with, and FIG. 4b is a flowchart showing the process executed by the second edge amount extracting unit 34. The mode of operation of the second edge amount extracting unit 34 is described in the following with reference to FIGS. 2 and 4.

In the process executed by the second edge amount extracting unit 34, an N×N region (window, N=5) is defined around the object pixel P (second pixel), and the window is shifted by one pixel as each corresponding object pixel is processed.

As shown in FIG. 4b, first of all, the second edge amount extracting unit 34 computes the average value of the pixels included in the N×N region of the entire infrared light image data (Y) (ST401). The central pixel Q may be either included in or excluded from this averaging process. The difference between the pixel value of the object pixel Q and the average value is computed in step ST401 (“value of the object pixel Q”−“average value”), and this difference (relative value) is set as a second edge value (ST402). The second edge value can be either positive or negative. The second edge value may also be obtained by using any of the edge detection filters mentioned above.

Upon completion of the process of step ST402, it is then determined if the foregoing process has been executed to all of the pixels Q (ST403). If so (Yes in step ST403), the program flow is ended. If no (No in step ST403), a window centered around the next object pixel is defined (ST404).

Reference is now made to FIG. 2 once again. Upon completion of the control flow shown in FIG. 4, the first edge amount is extracted from each pixel contained in the visible light image (Y) by the first edge amount extracting unit 33a, and the second edge amount is extracted from each pixel contained in the infrared light image by the second edge amount extracting unit 34. The first edge amounts and the second edge amounts are forwarded to the noise pixel determining unit 35.

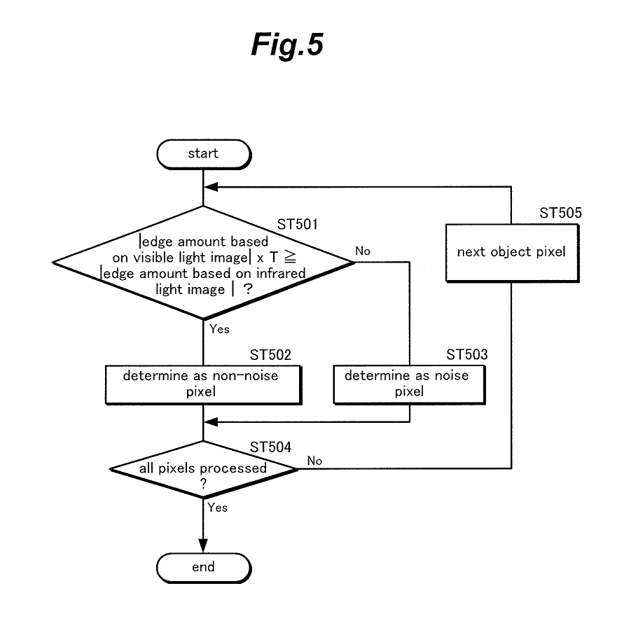

FIG. 5 is a flowchart showing the control flow of the noise pixel determining unit 35. The mode of operation of the noise pixel determining unit 35 is described in the following with reference to FIGS. 2 and 5.

The noise pixel determining unit 35 multiplies a coefficient T to the absolute value of the first edge amount for each object pixel P, and compares the product with the absolute value of the second edge amount of the corresponding object pixel Q (ST501). The coordinate of each object pixel P in the Y plane having the visible light image data (Y) arranged thereon is identical to that of the corresponding object pixel Q on the Ir plane having the infrared light image data arranged thereon.

The coefficient T is greater than zero, and

T=(Normalizing coefficient for the contrast of visible light image data (Y))/(Normalizing coefficient for the contrast of infrared light image data) Eq. 4

where

(Normalizing coefficient for the contrast of visible light image data (Y))=255/(difference between the maximum and minimum of the pixel values of the visible light image (Y)) Eq. 5

(Normalizing coefficient for the contrast of infrared light image data)=255/(difference between the maximum and minimum of the pixel values of the infrared light image) Eq. 6

Thus, it is determined if each object pixel P is a noise pixel or not while the visible light image (Y) and the infrared light image are adjusted to a same contrast condition.

When the relationship

(Absolute value of first edge amount based on visible light image (Y))×(coefficient T) equal to or greater than (Absolute value of second edge amount based on infrared light image) Eq. 7

holds (Yes in step ST501), the object pixel P is determined to be a non-noise pixel (ST502). If the condition in step ST501 is not met (No in step ST501), the object pixel P is determined to be a noise pixel (ST503). In other words, based on the standard set as discussed above, the noise pixel determining unit 35 determines an object pixel P to be a noise pixel when the first edge amount based on the visible light image (Y) is comparatively smaller than the second edge amount.

Upon completion of the process of step ST502 (or step ST503), it is determined if the foregoing process has been executed to all of the object pixels (ST504). If so (Yes in step ST504), the program flow is ended. If no (No in step ST504), a window centered around the next object pixel is defined (ST505).

The description is continued with reference to FIG. 2. Upon completion of the execution of the control flow of the flowchart shown in FIG. 5, the noise pixel determining unit 35 has determined if each of the object pixels contained in the visible light image (Y) is a noise pixel or not. This determination result is forwarded to an edge component generating unit 36a forming a part of an edge enhancement processing unit 36. The edge component generating unit 36a additionally receives an edge direction consisting of a sign determined from the first edge amount based on the visible light image (Y) from the edge direction extracting unit 33b and the second edge amount based on the infrared light image from the second edge amount extracting unit 34. Based on this data, the edge component generating unit 36a generates an edge component that is to be added to each object pixel.

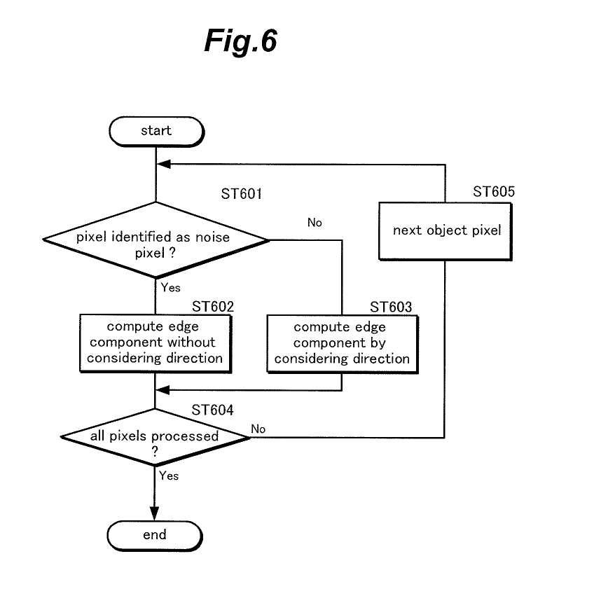

FIG. 6 is a flowchart showing the control flow for the edge component generating unit 36a. The mode of operation of the edge component generating unit 36a is now described in the following with reference to FIGS. 2 and 6.

In the edge component generating unit 36a, it is determined if the object pixel P is a noise pixel (ST601). If the object pixel P is a noise pixel (Yes in step ST601), an edge component is generated without considering the edge direction (ST602). Conversely, if the object pixel P is not a noise pixel (No in step ST601), an edge component is generated by considering the edge direction (ST603).

In the generation of the edge component by considering the edge direction, the edge component Eg is computed by the following formula which takes into account the edge direction (which is either+1 or −1) determined with respect to the first edge amount.

Eg=(Edge direction)×(Absolute value of second edge amount)×alpha Eq. 7

In the generation of the edge component without considering the edge direction, the edge component Eg is computed by the following formula without taking into account the edge direction.

Eg=(Second edge amount)×beta Eq. 8

alpha and beta are values greater than zero, and the magnitude of edge enhancement can be adjusted by varying the values of these coefficients. The greater the values of alpha and beta are, the greater the edge enhancement effect becomes.

Upon completion of the process of step ST602 (step ST603), it is then determined if the foregoing process has been executed to all of the pixels P (ST604). If so (Yes in step ST604), the program flow is ended. If no (No in step ST604), the succeeding pixel is processed (ST605).

The description is continued by referring to FIG. 2 once again. Upon completion of the control flow of the flowchart of FIG. 6, the edge component Eg for each of the object pixels P of the visible light image (Y) has been computed, and the obtained edge components Eg are forwarded to a combination processing unit 36b.

The combination processing unit 36b acquires pixel values (visible light image (Y)) corresponding to the coordinates of the object pixels P from a luminance/color information separating unit 32, and adds the corresponding edge value to each pixel value. Thereby, the visible light image data (Y) or the luminance information thereof is edge enhanced by the edge components extracted from the infrared light image data.

As discussed above, the image processing device 3 of the first embodiment comprises a first edge amount extracting unit 33a for extracting a first edge amount from each of a plurality of first pixels that form an image captured from an image object under a first condition, a second edge amount extracting unit 34 for extracting a second edge amount from each of a plurality of second pixels that form an image captured from the same image object under a second condition different from the first condition, and an edge enhancement processing unit 36 for enhancing an edge of the first image based on each first edge amount according to the sign associated with the first edge amount and the corresponding second edge amount.

It can also be said that the image processing device 3 comprises a first edge extracting unit 33 for extracting the first edge amount for each of a plurality of pixels forming a first image and determining a direction of the first edge indicating whether the first edge is a rising edge or a falling edge for each pixel, a second edge extracting unit 34 for extracting a second edge amount for each of a plurality of second pixels forming a second image obtained from a same image object as the first image under a different condition, an edge component generating unit 36a for determining a compensating amount based on each second edge amount and generating an edge component consisting of the compensating amount accompanied by a positive or a negative sign determined from an edge direction, and a combination processing unit 36b for combining each pixel with the corresponding edge component.

Then, based on the luminance information (Y) with edge enhancement and the color information (I, Q) produced from the luminance/color information separating unit 32, the combination processing unit 36b produces the visible light image data (RGB) from the following formulas.

R=Y+0.9489×I+0.6561×Q Eq.9

G=Y−0.2645×I−0.6847×Q Eq.10

B=Y−1.1270×I+1.8050×Q Eq.11

The combination processing unit 36b then forwards the computed visible light data (RGB) to a display device 38.

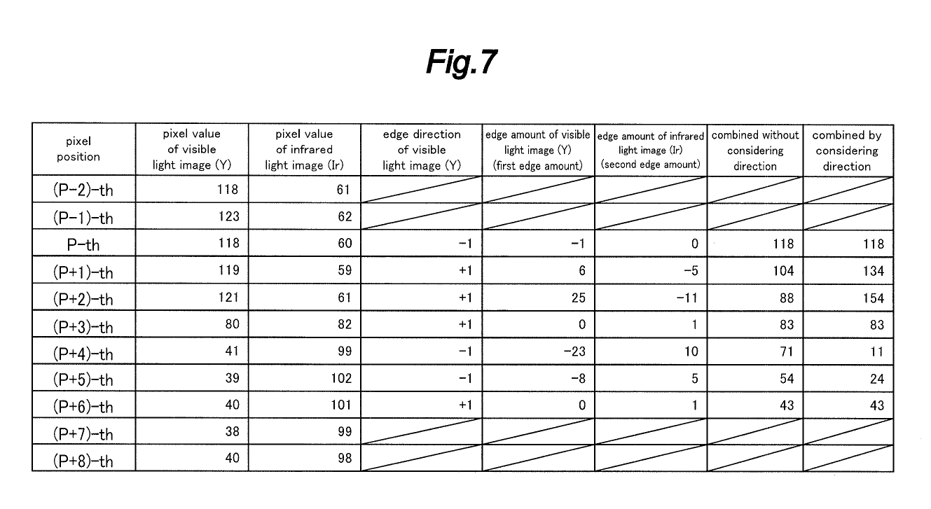

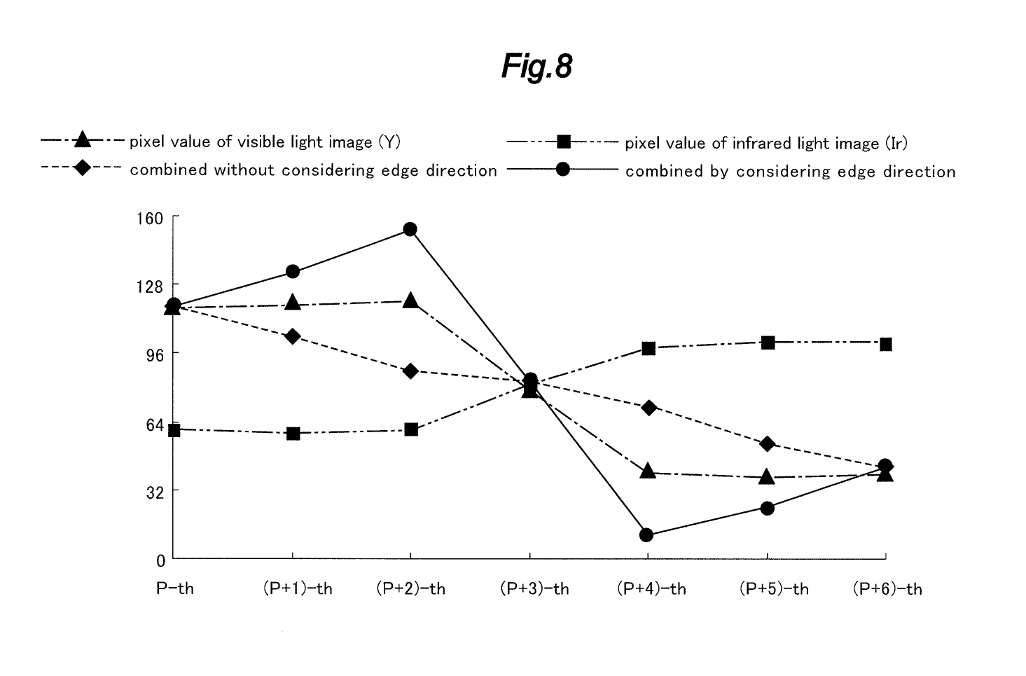

FIG. 7 is a table showing the effect of considering the edge direction of the visible light data (Y) on the results of edge enhancement, and FIG. 8 is a graph showing the results of edge enhancement. The effect and advantages of the present invention are discussed in the following with reference to FIG. 2 in addition to FIGS. 7 and 8.

Referring to FIG. 2, the “pixel value of visible light image (Y)” corresponds to the output (luminance information) of the luminance/color information separating unit 32, and the “pixel value of infrared light image” corresponds to the infrared light image data produced from the storage unit 31. The “edge direction of visible light image (Y)” corresponds to the output of the edge direction extracting unit 33b, the “edge amount of visible light image (Y)” corresponds to the first edge amount or the output of the first edge amount extracting unit 33a, and the “edge amount of infrared light image” corresponds to the second edge amount or the output of the second edge amount extracting unit 34. In the first embodiment, as discussed above, when performing edge enhancement on the visible light image (Y), the edge direction is generally taken into account. FIGS. 7 and 8 compare the cases where the images are combined with the edge direction taken into account and the images are combined without the edge direction taken into account.

In FIG. 7,

(Pixel value when combined without considering edge direction)=(Pixel value of visible light image (Y))+(Edge amount of infrared light image (second edge amount)×beta Eq. 12

(Pixel value when combined by considering edge direction)=(Pixel value of visible light image (Y))+(Edge direction)×(Absolute value of edge amount of infrared light image (second edge amount))×alpha Eq. 13

where both alpha and beta are “3” in the illustrated embodiment.

Consider the position of the (P+1)-th pixel. When combined without considering the edge direction,

(Pixel value without considering edge direction)=119+(−5)×3=104

(Pixel value by considering edge direction)=119+(+1)×(5)×3=134

With respect to the P-th to the (P+6)-th pixels, FIG. 8 plots and connects the “pixel values of visible light image (Y)” with black triangles and a chain-dot line, the “pixel values of infrared light image” with black squares and a double-dot chain-dot line, the pixel values “when combined without considering edge direction” with black rhombuses and a broken line, and the pixel values “when combined by considering edge direction” with black circles and a solid line.

As can be appreciated from FIG. 8, the “pixel values of visible light image (Y)” (black triangles) define a falling edge from the (P+2)-th to the (P+4)-th pixels, but the “pixel values of infrared light image” (black squares) define a rising edge in the same region. Thus, in terms of a pixel array, the two images captured at two different wavelengths or the visible light image and the infrared light image may demonstrate opposite tendencies, one rising and the other falling, or an opposite phase relationship to each other.

Because of this reversion of edge directions, “when combined without considering edge direction” (black rhombuses), the visible light image and the infrared light image cancel out each other so that the edge which should exist between the P-th to the (P+6)-th pixels has disappeared. On the other hand, “when combined by considering edge direction” (black circles), according to Eq. 13, before and after the (P+3)-th pixels where a edge should exist, the pixel value increases from 121 to 154 at the (P+2)-th pixel and the pixel value decreases from 44 to 11 at the (P+4)-th pixel, with the result that the edge that should exist in the visible light image (Y) is further enhanced. As a result, the finally produced visible light image (RGB) based on the visible light image (Y) demonstrates a higher visibility.

More specifically, as shown in FIG. 8, the visible light image (Y) is edge enhanced by adding a pixel value (edge component) based on the second edge amount to each of the pixels of the visible light image (Y) that have greater pixel values than the surrounding pixels (or by further increasing the pixel values of those pixels that have greater pixel values than the surrounding pixels) and subtracting a pixel value (edge component) based on the second edge amount from each of the pixels of the visible light image (Y) that have smaller pixel values than the surrounding pixels (or by further reducing the pixel values of those pixels that have smaller pixel values than the surrounding pixels).

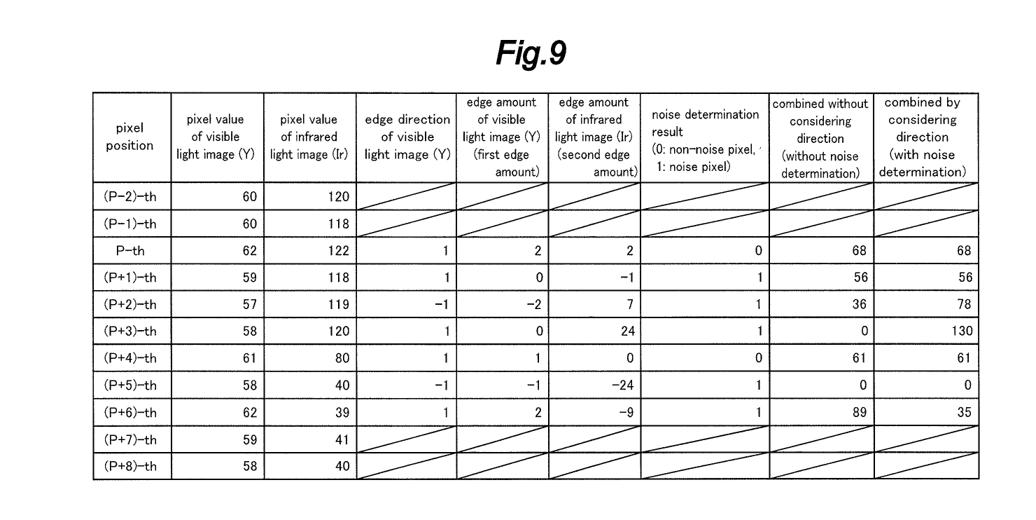

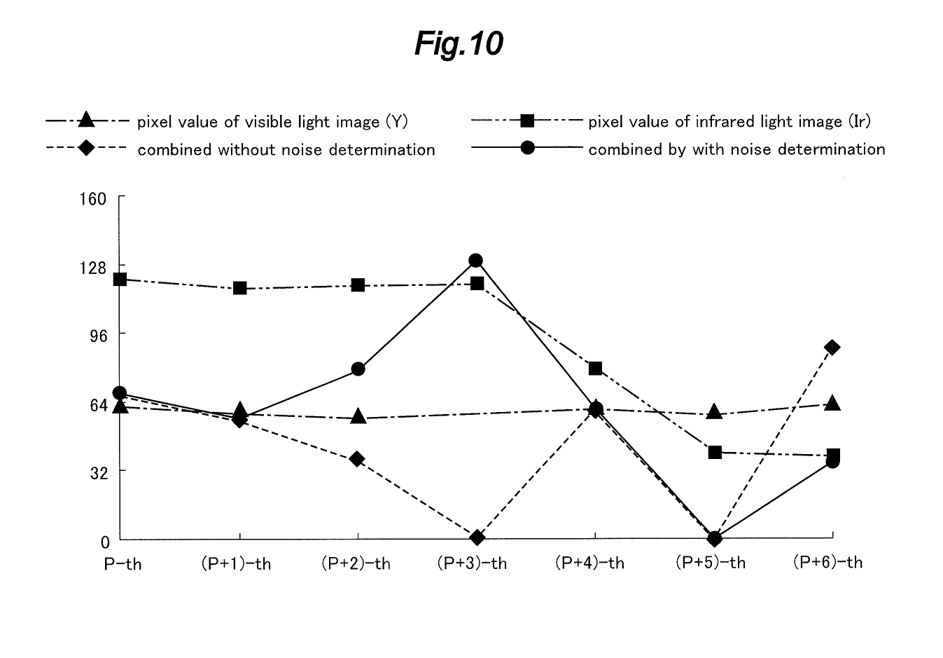

FIG. 9 is a table showing the result of edge enhancement when the noise pixel determination has been performed and has not been performed while the edge direction of the visible light image is considered, and FIG. 10 is a graphic representation of the result of edge enhancement shown in FIG. 9.

FIG. 9 differs from FIG. 7 in including the column of “noise determination result”. The “noise determination result” corresponds to the output of the noise pixel determination unit 35 (FIG. 2), and “noise determination result=1” indicates a noise pixel while “noise determination result=0” indicates a non-noise pixel. As discussed in conjunction with steps ST501, ST502 and ST503 in FIG. 5, the noise pixel determination unit 35 determines if each of the object pixels P of the visible light image (Y) is a noise pixel or not according to the test criterion given by Eq. 7.

As discussed above, in the first embodiment, when performing edge enhancement on the visible light image (Y), the edge direction is considered by applying Eq. 13, but as an exceptional process, as far as those determined to be noise pixels are concerned, the edge is combined by applying Eq. 12 without considering the edge direction.

The value of coefficient T was “2” in FIGS. 9 and 10. The value of beta in Eq. 12 and the value of alpha in Eq. 13 were both “3”.

When the (P+4)-th pixel is considered, for example, the “noise determination result=0 so that this pixel is a non-noise pixel. Therefore, the edge direction is considered, and Eq. 13 is used for the computation of the pixel value. More specifically,

pixel value=61+(+1)×0×3=61.

When the (P+3)-th pixel is considered, for example, the “noise determination result=1 so that this pixel is a noise pixel. Therefore, the edge direction is not considered, and Eq. 12 is used for the computation of the pixel value. More specifically,

pixel value=58+24×3=130.

With respect to the P-th to the (P+6)-th pixels, FIG. 10 plots and connects the “pixel values of visible light image (Y)” with black triangles and a chain-dot line, the “pixel values of infrared light image” with black squares and a double-dot chain-dot line, the pixel values “when combined without considering edge direction” with black rhombuses and a broken line, and the pixel values “when combined by considering edge direction” with black circles and a solid line.

As shown in FIG. 10, the “pixel values of visible light image (Y)” (black triangles) demonstrate very little changes from the P-th to the (P+6)-th pixels. However, as shown in FIG. 9, the first edge amount includes small fluctuations in both positive and negative directions in a region ranging from the P-th to the (P+6)-th pixels. Such small fluctuations are not likely to be caused by any edge components but by noises (such as shot noises) which are produced typically when the level of the incident light to the image sensor is low. On the other hand, the “pixel values of infrared light image” (black squares) define a falling edge from the (P+3)-th to the (P+5)-th pixels. Thus, in terms of a pixel array, the two images captured at two different wavelengths or the visible light image and the infrared light image may demonstrate different patterns, one being flat and the other demonstrating an edge.

When the object pixel P is a noise pixel, considering the edge direction of the visible light image (Y), as shown by the case “when combined without considering edge direction” (black rhombuses), may cause an unnatural edge component to be generated owing to the influences of the noises contained in the visible light image (Y). On the other hand, “when combined by considering edge direction” (black circles), once the object pixel P is determined to be a noise pixel, the edge direction based on the first edge amount generated from the visible light image (Y) is disregarded so that the edge of the infrared light image is directly put in place, and a natural edge can be obtained.

As discussed above in conjunction with the flowcharts of FIGS. 3 to 6, the present invention provides an image processing method as one aspect thereof so that a computer program encoding such an image processing method may be stored in the program memory mentioned above.

### Second Embodiment

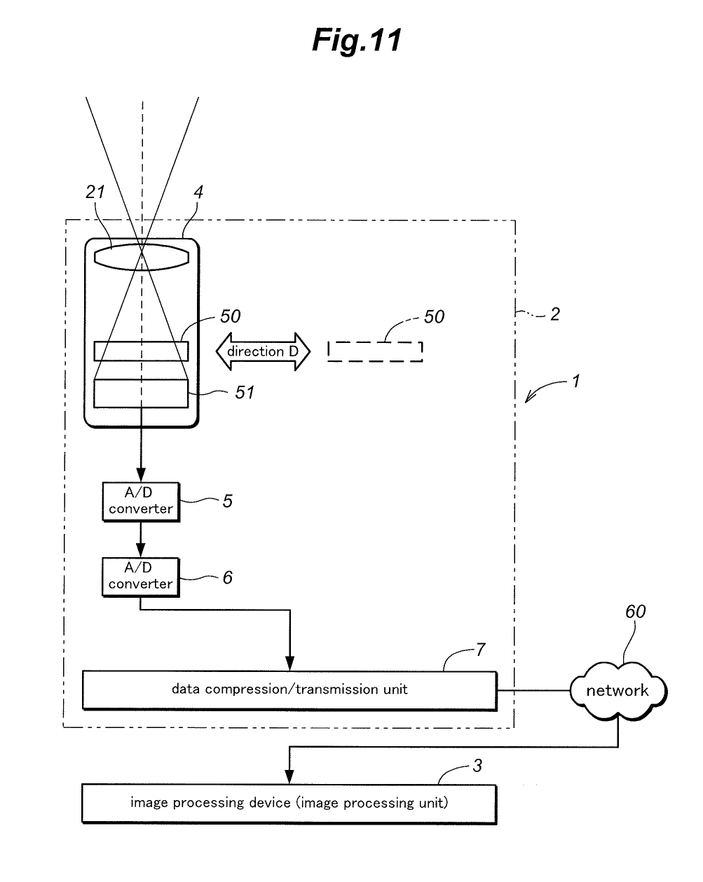

FIG. 11 is a structure view showing an overall structure of an image processing system given as a second embodiment of the present invention. The image acquiring unit 2 of the first embodiment included a left camera 4L for capturing a visible light image (RGB) and a right camera 4R for capturing an infrared light image, but the image acquiring unit 2 of the second embodiment includes only a single camera 4.

The camera 4 consists of an optical system including a lens 21, an imaging device 51 and an infrared light cut filter 50. The imaging device 51 may use either a color image sensor or a monochromatic image sensor. The infrared light cut filter 50 is moveable in the direction indicated by D by using a drive source and a drive mechanism not shown in the drawing so that the infrared light cut filter 50 can be selectively placed into and out of the space between the lens 21 and the imaging device 51 by issuing a command to the image acquiring unit 2 from outside via a network 60.

When the infrared light cut filter 50 is placed in the space between the lens 21 and the imaging device 51, an image of an image object can be captured as a visible light image (RGB or Y) or under the first condition. When the infrared light cut filter 50 is removed from the space between the lens 21 and the imaging device 51, an image of an image object can be captured as an infrared light image or under the second condition.

The placement and removal of the infrared light cut filter 50 is effected by a mechanical movement so that a certain time difference is inevitable between the visible light image (RGB or Y) and the infrared light image. The analog image signal from the camera 4 is converted into digital image data by an A/D converter 5, and forwarded to a pre-processing unit 6. In spite of the time difference between the two images, as long as the motion of the image object is not rapid, such as the rise of the water level, no problem arises.

In the pre-processing unit 6, depending on whether the received digital image data is visible light image data (RGB or Y) or the infrared light image, the corresponding process discussed above in conjunction with the first embodiment is executed. Thereafter, the visible light image (RGB or Y) and the infrared light image are processed by the data compression/transmission unit 7, and transmitted to an image processing device 3 via the network 60. The subsequent processes are not different from those of the first embodiment, and are omitted from the following description.

### Third Embodiment

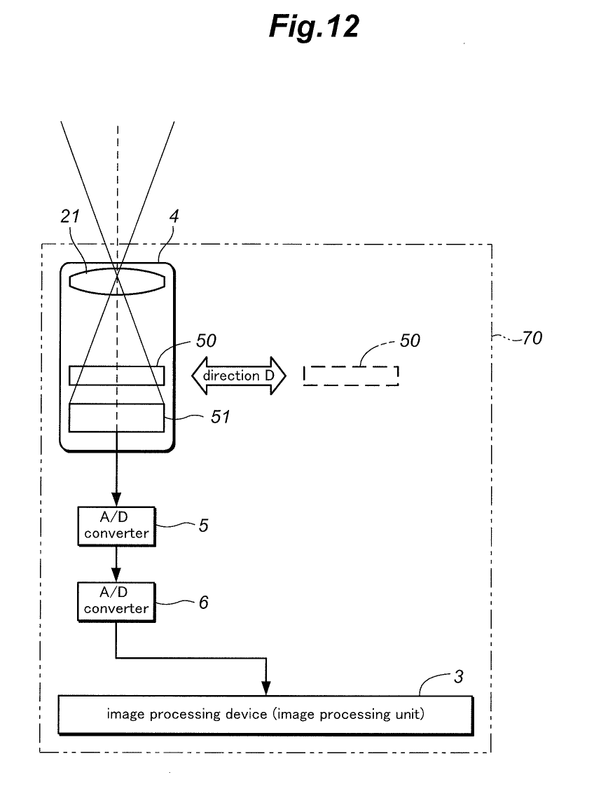

FIG. 12 is a structure view showing an overall structure of an image processing system 70 given as a third embodiment of the present invention. The image acquiring unit 2 was located remotely from the image processing device 3 such that the image data is transmitted from the image acquiring unit 2 to the image processing device 3 in the first and second embodiments. On the other hand, in the third embodiment, the image processing unit 3 is internally provided in the image processing system 70 such that the output of the pre-processing unit 6 is directly forwarded to the image processing unit 3.

The image processing system 70 of the third embodiment is provided with a selectively moveable infrared light cut filter 50, a camera 4 and an A/D converter 5 similar to those of the second embodiment. The image processing unit 3 is omitted from the following description because it is similar to the image processing device 3 of the first embodiment.

The structure of the twin lens camera of the first embodiment may also be combined with the third embodiment so that the image data acquired by the two lenses of the camera may be directly forwarded to the image processing unit 3, instead of using the moveable infrared light cut filter.

As can be appreciated from the foregoing description, the visible light image (Y or RGB) is essentially the image that is to be displayed on a monitor or the like for the viewing of the user. According to the present invention, a first edge amount is extracted from each of a plurality of object pixels P forming a first image for display, and a second edge amount is extracted from each of a plurality of object pixels Q forming a second image not for display. An edge of the image for display is enhanced for each object pixel by using the sign (edge direction) of the first edge amount and the second edge amount. Thus, according to the present invention, the infrared light image is used for enhancing an edge of the visible light image (Y) for display. Therefore, even when the edge in the visible light image (Y) is obscured owing to external interferences such as dense fog, the edge of the visible light image (Y) can be enhanced by using the edge components extracted from the infrared light image. Furthermore, as the combination of the edge components is performed by taking into account the edge directions of the visible light image, the edge of the visible light image can be effectively enhanced.

According to an aspect of the present invention, the user may also use the infrared light image (which may be treated as a single plane image similar to the visible light image (Y)) for display. In such a case, the first edge amount and the edge direction are extracted from the infrared light image (used as the first image) for each first pixel, the second edge amount is extracted from the visible light image (Y) (used as the second image), and these images are combined as discussed above so that an edge enhancement may be applied to the infrared light image for the image to be displayed with clear edges. This method is particularly effective when far infrared light is used for the infrared light. More specifically, when far infrared light images (temperature distributions) are obtained by using a thermo sensor, edges in the images are normally unclear. Therefore, clear edges of a visible light image may be advantageously combined with the infrared light image by considering the edge directions so that a infrared light image obtained by using a thermo sensor can be made into a highly clear (high resolution) image. However, because far infrared light images are often colored so as to clearly indicate temperature distributions, it may be desirable to display at least a part of the edges in a monochromatic representation so as to distinguish the edge enhanced parts from temperature distribution patterns. Thus, it is possible not only to exchange the first image and the second image with each other but also to obtain the first image as a far infrared image and the second image as a near infrared image.

As discussed earlier in conjunction with the first embodiment, according to another aspect of the present invention, the edge contained in an image obtained under a first condition or a visible light image (Y) is enhanced by using the second edge amount extracted from an image obtained under a second condition or an infrared light image, but the second image amount may also be extracted from images of different wavelengths. The image that is to be enhanced is not necessarily based on luminance information but may also be based on color information. It is also possible to use an ultraviolet light image (image obtained by using near ultraviolet light having a wavelength of 380 nm to 200 nm) instead of an infrared light image so that the second edge amount may be extracted from the ultraviolet light image. An ultraviolet light image can be obtained by using an ultraviolet light pass filter (which may absorb visible light), instead of the infrared light pass filter 25R (FIG. 1). The imaging device 23R (FIG. 1) typically consisting of CMOS or CCD has a sensitivity to near ultraviolet light of the required wavelength range, no special components are required for obtaining ultraviolet light images except for the ultraviolet light pass filter.

As long as the image obtained under the first condition (for display) and the image obtained under the second condition (not for display) cover a same image object, the two images can be obtained in any sorts of light (electromagnetic wave) having any two different wavelengths.

The second image may consist of a distance image obtained by using the so-called TOF (time of flight) method. More specifically, the edge contained in the visible light image (Y) may be enhanced by using the obtained distance information (being far or near). As can be readily appreciated, the image to be display may consist of the infrared light image and the image not to be displayed may consist of the distance image.

In the first to the third embodiments, a filter such as an infrared light cut filter 25L and an infrared light pass filter 25R was placed between the imaging device 23L, 23R and the lens 21 (FIG. 1) to obtain the visible light image (RGB) and the infrared light image, but it is also possible to use an imaging device provided with so-called RGBW (RGBIr) pixels instead. In such a case, the need for a filter such as an infrared light cut filter 25L and an infrared light pass filter 25R can be eliminated.

In the first to the third embodiments, the edge amount was obtained and the edge was enhanced for each pixel. However, the image may be divided into image segments of any desired configuration so that the edge amount may be obtained and the edge may be enhanced for each of such segments. Each image segment may consist of any number of pixels.

In the foregoing embodiments, prescribed coefficients were multiplied to the second edge amount to add it to or subtract it from the corresponding pixel value of the visible light image, but it is also possible to multiply a coefficient based on the second edge amount to the corresponding pixel value of the visible light image.

Although the present invention has been described in terms of preferred embodiments thereof, it is obvious to a person skilled in the art that various alterations and modifications are possible without departing from the scope of the present invention which is set forth in the appended claims. The contents of the original Japanese patent application on which the Paris Convention priority claim is made for the present application as well as the contents of the prior art references mentioned in this application are incorporated in this application by reference.

The various components of the image processing device, the image capturing device and the image processing system described above are not entirely indispensable, but may be partly omitted and/or substituted without departing from the spirit of the present invention.

### INDUSTRIAL APPLICABILITY

The image processing method and the image processing system of the present invention use a first image and a second image obtained from a same object under different conditions, and allow the edge contained in the first image for display to be effectively enhanced by using the edge component of the second image. Therefore, the present invention can be favorably applied to monitor cameras such as monitor cameras for disaster control which are required to capture clear images under all conditions.

### REFERENCE SIGNS LIST

1 image processing system
2 image capturing unit
3 image processing device (image processing unit)
4L left camera (first camera)
4R right camera (second camera)
23L imaging device
23R imaging device
25L infrared light cut filter
25R infrared light pass filter
32 luminance/color separating unit
33 first edge extracting unit
33a first edge amount extracting unit
33b edge direction extracting unit
34 second edge extracting unit (second edge amount extracting unit)
35 noise pixel determining unit
36 edge enhancement processing unit
36a edge component generating unit
37b combination processing unit

1. An image processing method, comprising the steps of:
extracting a first edge amount for each of a plurality of first image segments forming an image of an image object obtained under a first condition as a relative value with respect to at least one adjoining first image segment;
extracting a second edge amount for each of a plurality of second image segments forming an image of the same image object obtained under a second condition different from the first condition as a relative value with respect to at least one adjoining second image segment; and
edge enhancing the image obtained under the first condition for each first image segment thereof according to a sign of the corresponding first edge amount and the second edge amount of the corresponding second image segment.

2. The image processing method according to claim 1, wherein for each first image segment, a value based on an absolute value of the corresponding second edge amount is added to the first edge amount of the first image segment when the first edge amount is positive, and a value based on an absolute value of the corresponding second edge amount is subtracted from the first edge amount of the first image segment when the first edge amount is negative.

3. The image processing method according to claim 1, wherein the first edge amount for each first image segment is given as a difference between a value of the first image segment and an average of values of surrounding first image segments, and the second edge amount for each second image segment is given as a difference between a value of the second image segment and an average of values of surrounding second image segments.

4. The image processing method according to claim 2, wherein the value of each first image segment is given by a pixel value of luminance information of the first image segment.

5. The image processing method according to claim 1, wherein the second condition differs from the first condition in a wavelength of light that is used.

6. The image processing method according to claim 4, wherein the image obtained under the first condition comprises a visible light image, and the image obtained under the second condition comprises an infrared light image.

7. The image processing method according to claim 4, wherein the image obtained under the first condition comprises an infrared light image, and the image obtained under the second condition comprises a visible light image.

8. The image processing method according to claim 1, wherein the images obtained under the first and second conditions cover a same region of the image object.

9. The image processing method according to claim 1, wherein the first and second image segments consist of pixels.

10. The image processing method according to claim 1, further comprising the step of determining if each first image segment is a noise image segment containing noises according to the corresponding first edge amount and second edge amount;
when the first image segment consists of a noise image segment, the step of edge enhancing the image obtained under the first condition being based solely on the corresponding second edge amount.

11. The image processing method according to claim 10, wherein when the first edge amount of one of the first image segments normalized according to a contrast thereof is smaller than the second edge amount of the corresponding second image segment, the said first image segment is determined as a noise image segment.

12. An image processing system, comprising:
an image acquiring unit for acquiring an image of an image object under a first condition and acquiring an image of the same image object under a second condition different from the first condition;
a first edge amount extracting unit for extracting a first edge amount for each of a plurality of first image segments forming the image obtained under the first condition as a relative value with respect to at least one adjoining first image segment;
a second edge amount extracting unit for extracting a second edge amount for each of a plurality of second image segments forming the image obtained under the second condition as a relative value with respect to at least one adjoining second image segment; and
an edge enhancement processing unit for edge enhancing the image obtained under the first condition for each first image segment thereof according to a sign of the corresponding first edge amount and the second edge amount of the corresponding second image segment.

13. The image processing system according to claim 12, wherein the image acquiring unit comprises a camera configured to capture an image in both visible light and infrared light, and an infrared light cut filter that can be selectively placed in an optical system of the camera, the first condition being achieved by placing the infrared light cut filter in the optical system, and the second condition being achieved by removing the infrared light cut filter from the optical system.

14. The image processing system according to claim 12, wherein the image acquiring unit comprises a first camera for capturing an image under the first condition and a second camera for capturing an image under the second condition.

15. The image processing system according to claim 12, wherein the edge enhancement processing unit adds a value corresponding to an absolute value of the second edge amount to a value of the first image segment when a sign of the first edge amount is positive, and subtracts a value corresponding to an absolute value of the second edge amount from a value of the first image segment when a sign of the first edge amount is negative.

16. The image processing system according to claim 12, wherein the first edge amount extracting unit gives the first edge amount of each first image segment by a difference between a value of the first image segment and an average of values of surrounding first image segments, and
the second edge amount extracting unit gives the second edge amount of each second image segment by a difference between a value of the second image segment and an average of values of surrounding second image segments.

17. The image processing system according to claim 15, wherein the value of each first image segment is given by a pixel value based on luminance information of the first image segment.

18. The image processing system according to claim 12, wherein the second condition differs from the first condition in a wavelength of light that is used.

19. The image processing system according to claim 17, wherein the image obtained under the first condition comprises a visible light image, and the image obtained under the second condition comprises an infrared light image.

20. The image processing system according to claim 12, wherein the images obtained under the first and second conditions cover a same region of the image object.
